(19) United States
(12) Patent Application Publication
(10) Pub. No.: US 2017/0169319 A1
(43) Pub. Date: Jun. 15, 2017

(54) Legacy Card

(71) Applicant: Emilyann Leilani Sandan, San Diego, CA (US)

(72) Inventor: Emilyann Leilani Sandan, San Diego, CA (US)

(21) Appl. No.: 15/373,674

(22) Filed: Dec. 9, 2016

Related U.S. Application Data
(60) Provisional application No. 62/267,129, filed on Dec. 14, 2015.

(51) Int. Cl. G06K 19/06

(52) U.S. Cl. CPC G06K 19/06028

(57) ABSTRACT

This invention is directed toward a card that is used by a person wishing to leave a tangible or intangible item to a future recipient and beneficiary(ies). The user creates a Moment online, which is then sealed in a Moment Capsule by a company owning or licensing this invention. The user designates a recipient and beneficiary(ies) of the Moment, and sets a triggering date or event for the Moment to be delivered to the beneficiary. The company creates a physical “Legacy Card” which is mailed to the user and/or the beneficiary, upon which information identifying the Moment is stored.

### CROSS REFERENCE TO RELATED APPLICATIONS

This application claims priority back to U.S. Provisional No. 62/267,129 filed Dec. 14, 2015 the contents of which are incorporated by reference into this application.

### STATEMENT REGARDING FEDERALLY SPONSORED RESEARCH OR DEVELOPMENT

This invention was not federally sponsored.

### INVENTOR

Emilyann Leilani Sandan

### BACKGROUND OF THE INVENTION

Field of the invention: This invention relates to a card, referred to generally as a legacy card, and a method of using the legacy card to accomplish a number of desired goals. The basic premise under which the legacy card works is that people would like to leave memories and in some cases items, to others in the future. For example, a grandparent not expecting to live to a grandchild's 50th birthday might want to leave that grandchild a memory or other written document that would be delivered to the grandchild on that grandchild's 50th birthday. There are estate plans that handle the future delivery of assets from a donor to a beneficiary, but these are often done in a purely business transaction manner.

Thus, there exists a need for a means by which people can leave “memories” and gifts to a person, for future delivery, that can be personalized and yet kept safely until the time is ready for their delivery. The current invention provides just such a solution by having a card that is used by a person (user) wishing to leave a tangible or intangible item to a future beneficiary. A company owns or licenses the invention, and allows users to create one or more “Moments” online, which are then sealed in Moment Capsules by the company owning or licensing this invention. The user designates a recipient and beneficiary(ies) for each Moment, and sets a specific date, triggering date or event such as a life event or holiday for the Moment to be delivered to the recipient and beneficiary(ies). The company creates a physical “Legacy Card” which is mailed to the user, upon which information identifying the Moment is stored, and a “Words in Waiting” card that transmits a brief message indicating what may be in the Moment Capsule for the recipient and beneficiary(ies). Through these physical cards, the user sets up a future gift of thoughts, images, video, or even, optionally, tangible assets such as property or money if allowed under that state's laws.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a general flowchart of the invention according to a preferred form of the invention.

FIG. 2 is a flowchart showing how a bank or other trust holder could participate in the legacy process.

FIG. 3 is a flowchart showing how an estate planning attorney could participate in the legacy process.

FIG. 4 is an example of a “Words in Waiting” card.

FIG. 5 is an example of a “Legacy” card.

FIG. 6 is an example of a hard copy Moment being delivered under wax and seal.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

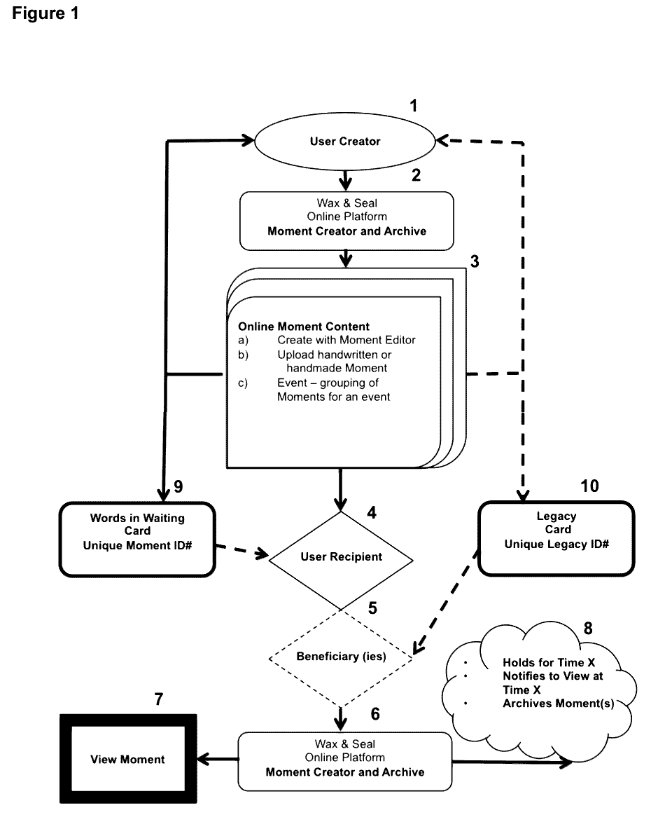

FIG. 1 is a general flowchart of the invention according to a preferred form of the invention. The general goal of the card and the use of the card is to create a personal archive that can become active at a later date to the benefit of another person. The invention proceeds as follows. A user of the invention (1, 11, 22) decides to leave some sort of legacy (10, 20, 31) to another person—the “Recipient” (4, 14, 25) or “Beneficiary(ies)” (5, 15, 26)—and begins by purchasing a “Moment Capsule” or “Moment” (2, 12, 23) from the company that owns the invention or licenses rights to it “the company”. The user (1, 11, 22) then, through the company's online platform (2, 12, 23), creates the “moment” (3, 13, 24) and the moment is stored by the company in electronic format (8, 18, 29). Storing data in electronic format is well known in the industry and this invention includes embodiments using any of the currently available data storage means and methods to create and store these moments. The original designee of the Moment is called the Recipient (4, 14, 25), but the user (1, 11, 22) of the invention can designate additional or alternate beneficiaries (5, 15, 26) as well. Indeed, the invention also contemplates that the original Recipient (4, 14, 25) can even name additional Recipients (4, 14, 25) and/or Beneficiaries (5, 15, 26). To simplify the use of the legacy card (10, 20, 31), all those who are in line to receive a Moment (6, 16, 27) will be referred to as Recipients (4, 14, 25) and Beneficiary(ies) (5, 15, 26)

The “Moment” can be basically anything, ranging from a letter or other personal communication not limited to images and video to a gift or bequest (3, 13, 24). The moment can be set to be given to the recipient (4, 14, 25) and beneficiary(ies) (5, 15, 26) at a certain date “To Tom on his 21st birthday” or to be triggered by a certain event “Should Tom marry and have a child, this moment shall trigger on his first child's first birthday” (8, 18, 29). The Moment is not only stored online on the company's database (6, 16, 27), but also sent to the recipient (4, 14, 25) and/or beneficiary(ies) (5, 15, 26), or to some person (such as an estate planning attorney) (32) or entity (such as a bank or trust holder) (21) that has been designated to oversee gifts and other interactions with recipients (4, 14, 25) and beneficiary(ies) (5, 15, 26). Depending on the user's desire (1, 11, 22), the user (1, 11, 22) and even recipient (4, 14, 25) and beneficiary(ies) (5, 15, 26) may have the option to create (3, 13, 24), review (7, 17, 28), search (6, 16, 27), notify for viewing (8, 18, 29), and store Moment Capsules on the platform (6, 16, 27).

The company owning or using this invention (6, 21, 32) provides an online platform where, after the user purchases the Moment Capsule (2, 12, 23), the user (1, 11, 22) can create the moment in a number of ways (3, 13, 24). First, the user (1, 11, 22) can choose from a variety of templates, frameworks and designs supplied by the company and type directly onto the template and/or upload pictures, images, video and other documents (3, 13, 24). Second, the user (1, 11, 22) can personally create the Moment “offline” and then upload the entire moment onto the company's server (3, 13, 24). Third, the user (1, 11, 22) can cooperate with other people to jointly create a grouping of Moments—either offline to be later loaded onto the company's server, or jointly created on the company's templates (3, 13, 24). No matter how the Moment is created, the user(s) (1, 11, 22) can select from a variety of fonts, sizes, colors, clip art, upload other content in other formats, and other known elements in word processing, graphic design, and video production software (3, 13, 24).

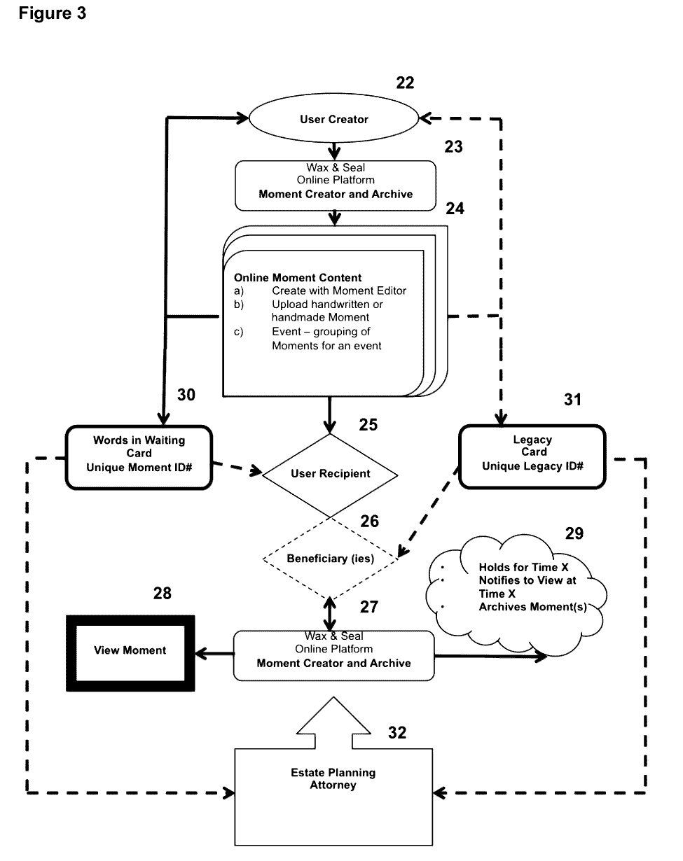

The company has a variety of means, such as docketing software, to “seal” the Moment into a Moment Capsule, which is then scheduled for release (8, 18, 29) to the recipient (4, 14, 25) and beneficiary(ies) (5, 15, 26) at some date in the future (8, 18, 29). As previously mentioned, the future date could be a set date (“Jan. 1, 2025”), such as a certain future date, a birthday, an anniversary, or some other special occasion with a fixed, certain date (8, 18, 29). The date could also be an open-ended future date contingent upon a certain event (“10 years from the day I die”), or a future date contingency upon an uncertain occurrence or occurrence (“10 years from the day I die or the date that Tom marries and has his first child, whichever occurs first”) (8, 18, 29). The Moment Capsule could also be scheduled to be delivered upon random events, and could be delivered in staggered stages as well (8, 18, 29). The role of an estate planner (FIG. 3) comes into play here to avoid the dreaded Rule Against Perpetuities and other estate planning problems.

Users (1, 11, 22) will work with the company to add recipients (4, 14, 25) and beneficiaries (5, 15, 26) for future notification of the Moments (8, 18, 29). The company will store, for perpetuity, the Moments in Moment Capsules which can be read/re-read/shared (6, 16, 27) by both the recipients (4, 14, 25) and beneficiaries (5, 15, 26), and for their future generations (6, 16, 27).

The Moment Capsules will be stored on a redundant cloud database for perpetuity, with multiple backups in case of failure of one database (8, 18, 29). Should one of more of the companies storing the Moment Capsules go out of business, the company could contract with an estate planning attorney (32), bank, (21) or other trust holder (21) for that person/organization to step in an either transfer the Moment Capsules to another company, or take over the trust obligations personally.

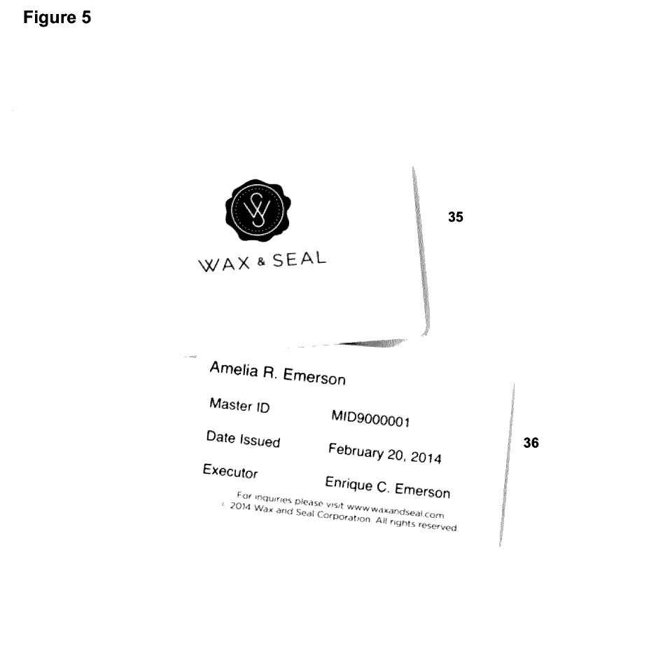

Turning to the actual legacy card itself (10, 20, 31, FIG. 5), the invention contemplates a physical card (35, 36). In a preferred embodiment, the card is the approximate size and shape as a credit card or gift card, but other sizes and shapes are contemplated (FIG. 5). One preferred embodiment calls for the card to be made of plastic, the approximate length, width and height of a credit card, and to have a unique watermark such as a Holokote watermark of the company on it (35, 36). However, it should be stressed that there are no limits to the material make-up of the card and can therefore be made of any physical material as contemplated.

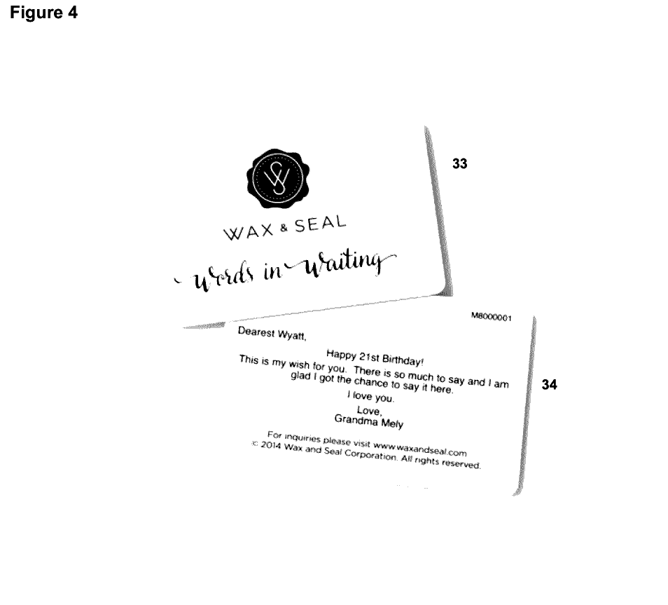

The company then creates a “Words in Waiting” card with a unique identification indicia, such as a number, a scan code, a QR code, or some other known means of personalizing a card (9, 19, 30, FIG. 4, 33, 34). The Words in Waiting card (33,34) serves as physical reminder that the Moments exist on company's database in Moment Capsules (6, 16, 27), and that at least one of these Moment Capsules has been designated for that particular recipient (4, 14, 25) and beneficiary(ies) (5, 15, 26) (multiple recipients are also contemplate, but for sake of simplicity, we are using one recipient for these examples). The physical “card” is created by the company upon finalization and sealing of each Moment Capsule (9, 19, 30, FIG. 4, 33, 34).

Users of the invention (1, 11, 22) will also have the option of ordering a “Legacy Card” from the company (10, 20, 31, FIG. 5). The Legacy Card (10, 20, 31, FIG. 5) will serve as a sort of will/trust card giving notice that Moments from this user exists on the company's database (6, 16, 27), and that Moments will be triggered on a certain date (8, 18, 29). An estate planning attorney (32) or Bank (21) or other trust holder (21) can work with the company to assist in transferring any property or items designated in the Moment Capsule to the recipient (4, 14, 25) and beneficiary(ies) (5, 15, 26). The Legacy Card (10, 20, 31, FIG. 5) will have personal identifiable data and the master customer identification to link all Moment Capsules created by the user (35, 36). The company's database (6, 16, 27) also has means to link all Moment Capsules directed toward a particular recipient (4, 14, 25) and beneficiary(ies) (5, 15, 26).

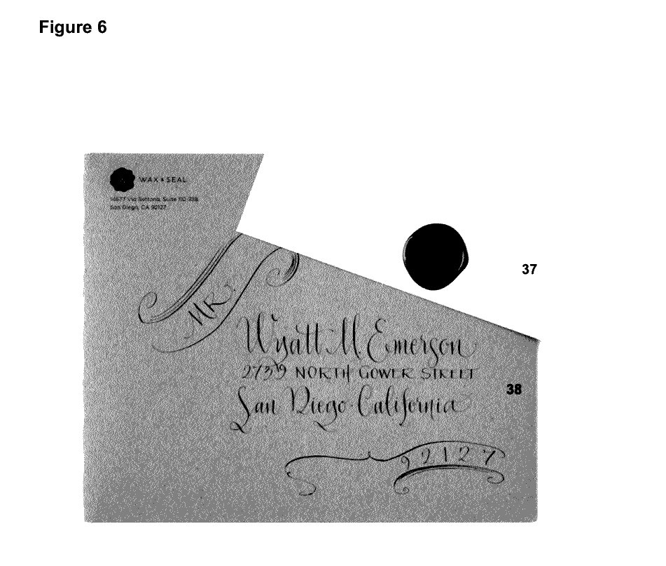

Users (1, 11, 22) will also have the option of ordering a “hard copy” version of the Moment (FIG. 6) to send on the specified date or event (with postal mail timing variations) (8, 18, 29) at an incremental cost to a recipient (4, 14, 25) and beneficiary(ies) (5, 15, 26). Users (1, 11, 22) may also order a hard copy of the Moment to be delivered to them for safe storage as well (FIG. 6, 37, 38). Should the user (1, 11, 22) order a hard copy, the hard copy of the Moment will be physically mailed to the recipient (4, 14, 25) and beneficiary(ies) (5, 15, 26) upon the triggering date (8, 18, 29) printed in paper and sealed in wax (FIG. 6, 37, 38). Other means of making the physical delivery of the Moment more ceremonial, such as messenger delivery, drone delivery, or having the moment delivered to a recipient (4, 14, 25) and beneficiary(ies) (5, 15, 26) place of work, etc. are contemplated. Again, while one preferred embodiment of the invention is used for purposes of illustration, there are no limits to the material make-up of the “hard copy” and can therefore be made of any physical material and delivered by any means to the recipient (4, 14, 25) and beneficiary(ies) (5, 15, 26) as contemplated.

Once the user (1, 11, 22) seals up the Moment in a Moment Capsule (3, 13, 24), the recipient (4, 14, 25) and beneficiary(ies) (5, 15, 26) can, at the option of the user (1, 11, 22), be notified that a Moment for his/her benefit has been created (8, 18, 29). The personal identification of the recipient (4, 14, 25) and beneficiary(ies) (5, 15, 26), such as address, phone number, email address, is provided by the user (1, 11, 22). It is highly advised that the user (1, 11, 22) agree to have the recipient (4, 14, 25) and beneficiary(ies) (5, 15, 26) notified, as this will give notice that a Moment is waiting for him/her, and give the recipient (4, 14, 25) and beneficiary(ies) (5, 15, 26) an incentive to keep the company notified of changes in address, phone number, email address, etc.

The user (1, 11, 22), the recipient (4, 14, 25) and beneficiary(ies) (5, 15, 26) can set reminder preferences with the company to request any other news relating to Words in Waiting (9, 19, 30, FIG. 4), Moments (6, 16, 27) and other notifications (8, 18, 29). Recipients (4, 14, 25) and Beneficiary(ies) (5, 15, 26) will have the option to order from the company a more formalized copy of the Words in Waiting (9, 19, 30, FIG. 4)/Moments (6, 16, 27), such as framed versions, photo books, and other known uses of memorializing events, however the items described are merely for purposes of illustration and not intended to be limiting in any manner—there are no limits to the material make-up of the Moment and can therefore be made of any physical material as contemplated.

Benefits to the user (1, 11, 22) of this invention are considerable. First, because the Moment Capsules are sold on an “as needed” basis, there are not ongoing subscription costs, and no need for a user to put a credit card on file with the company (2, 12, 23). Second, because the company provides a physical card (FIG. 4, 33, 34, FIG. 5, 35, 36) with each Moment Capsule and binds all created Moment Capsules to a Legacy card (FIG. 5, 35, 36), there is less chance that the Moment will be lost in time and no one will remember to activate it (6, 16, 27).

An additional component of the invention can offer a subscription model as an option in the future based on demand.

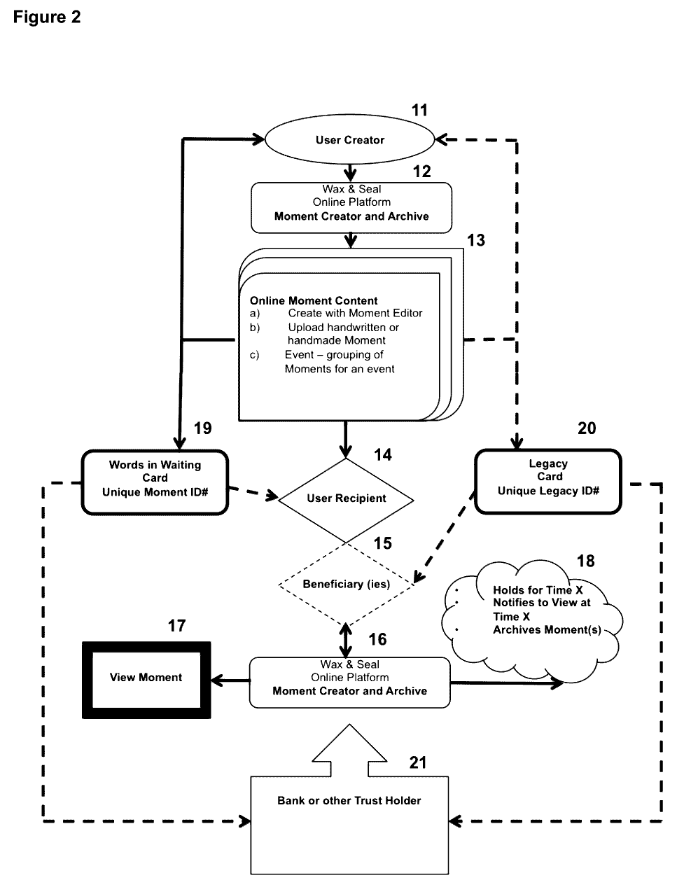

FIG. 2 is a flowchart showing how a bank or other trust holder could participate in the legacy process. In this example, the user (11) of the invention uses a bank (21) or other trust holder (21) to hold any physical or financial aspects of the Moment, such that once the triggering event or date is reached (18), the bank (21) or other trust holder (21) “breaks open” the Moment Capsule and delivers its contents (16) to the recipient (14) and beneficiary(ies) (15). The bank (21) or other trust holder (21) is kept abreast of the issues and events surrounding this particular Moment through the Words in Waiting card (19, FIG. 4, 33, 34) and the Legacy Card (20, FIG. 5, 35, 36) which will permit it access to the company's database (16) with respect to this particular Moment and Moment Capsule (16).

FIG. 3 is a flowchart showing how an estate planning attorney could participate in the legacy process. In this flowchart, an estate planning attorney (32) is used to assist in the designation of assets to be transferred from a user (22) to a recipient (25) and beneficiary(ies) (26), and in the actual release of the assets to the recipient (25) and beneficiary(ies) (26) upon the opening of the Moment Capsule as triggered by a specific date or event (29)

FIG. 4 is an example of a “Words in Waiting” card. On this card, the personalized message that provides a brief indication as to what is stored from the user (FIG. 4, 33, 34) to the recipient (4, 14, 25) and beneficiary(ies) (5, 15, 26) is displayed.

FIG. 5 is an example of a “Legacy” card. The Legacy card displays the unique identification (FIG. 5, 35, 36) for this user (1, 11, 22) and all Moments created. The user can set preferences as to how Moment content will be reviewed by a named Executor (35, 36, 10, 20, 31, 6, 16, 27). For example, the user (1, 11, 22) can decide that he/she would want the Executor (FIG. 5, 35, 36) to have knowledge of the Moments and recipients (4, 14, 25) and beneficiary(ies) (5, 15, 26) but may not want content divulged. The user can set preferences in a number of different ways as to the release of the Moment content (6, 16, 27).

FIG. 6 is an example of a “hard copy” Moment being delivered under wax and seal (37, 38)

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A system for distributing content comprising
a non-transitory computer readable medium;
a processor executing programming logic for interfacing with a user, the programming logic configured to:
accept a user identifier, a recipient identifier, a beneficiary(ies) identifier, content, and a trigger event; generate a unique identifier; and save the user identifier, recipient identifier, beneficiary(ies) identifier, executor identifier, content, trigger event, and unique identifier to the non-transitory computer readable medium; and a legacy card, where the legacy card comprises the recipient identifier, the beneficiary(ies) identifier, executor identifier, the trigger event, and the unique identifier.

2. The system of claim 1, further comprising a words in waiting card, where the words in waiting card comprises the content.

3. The system of claim 1, wherein the trigger event is a specific date, randomized date, life event, or holiday event.

4. The system of claim 1, wherein the programming logic is further configured to provide access to the content after the trigger event and upon receipt of the recipient identifier, beneficiary(ies) identifier, executor identifier

5. The system of claim 1, wherein the non-transitory computer readable medium comprises a database whereby the programming logic is configured to save the user identifier, recipient identifier, beneficiary(ies) identifier, executor identifier, content, trigger event, and unique identifier to the database.

6. The system of claim 1, wherein the content comprises a content identifier, where the content identifier references one or more items of tangible personal property.

7. The system of claim 1, wherein the recipient identifier is a name of a recipient.

8. The system of claim 1, wherein the recipient identifier comprises a name and an optional mailing address of a recipient.

9. The system of claim 8, wherein the address of the recipient primary identifier comprises an electronic mail address.

10. The system of claim 1, wherein the programming logic is further configured to:
accept a recipient update request, where the recipient update request comprises a second recipient identifier and the unique identifier; and
save the second recipient identifier to the non-transitory computer readable medium using the unique identifier.

11. The system of claim 1, wherein the beneficiary(ies) identifier is a name of a beneficiary(ies).

12. The system of claim 1, wherein the beneficiary(ies) identifier comprises of a name and an optional mailing address of a beneficiary(ies).

13. The system of claim 8, wherein the address of the beneficiary(ies) primary identifier comprises of an electronic mail address.

14. The system of claim 1, wherein the programming logic is further configured to:
accept a beneficiary(ies) update request, where the beneficiary(ies) update request comprises a second beneficiary(ies) identifier and the unique identifier; and save the second beneficiary(ies) identifier to the non-transitory computer readable medium using the unique identifier.

15. The system of claim 1, wherein the executor identifier is a name of an executor.

16. The system of claim 1, wherein the executor identifier comprises of a name and optional mailing address of an executor

17. The system of claim 8, wherein the address of the executor is the primary identifier comprises of an electronic mail address.

18. The system of claim 1, wherein the programming logic is further configured to:
accept an executor update request, where the executor update request comprises a second executor identifier and the unique identifier; and save the second executor identifier to the non-transitory computer readable medium using the unique identifier.

19. The system of claim 1, wherein the unique identifier of the legacy card is encoded.

20. The system of claim 1, wherein the encoded unique identifier of the legacy card is formatted as a barcode, identification number or similar identifier

21. A method of distributing content comprising the steps of:
accepting a user identifier, a recipient identifier, a beneficiary(ies) identifier, an executor identifier, content, and a trigger event; generating a unique identifier;
saving the user identifier, recipient identifier, beneficiary(ies) identifier, executor identifier, content, trigger event, and unique identifier to a non-transitory computer readable medium; and generating a legacy card, where the legacy card comprises the recipient identifier, the beneficiary(ies) identifier, the executor identifier, the trigger event, and the unique identifier printed thereon.

22. The method of claim 2, further comprising the step of generating a words in waiting card, where the words in waiting card comprises the content and the unique identifier.

23. The method of claim 2, wherein the trigger event is a specific date, randomized date, life event, or holiday event.

24. The method of claim 2, further comprising the step of providing access to the content after the trigger event and upon receipt of the recipient identifier, beneficiary(ies) identifier, executor identifier.

25. The method of claim 2, further comprising the steps of accepting a recipient, beneficiary(ies), executor update request, where the recipient, beneficiary(ies), executor update request comprises a second recipient, beneficiary(ies), executor identifier and the unique identifier; and saving the second recipient, beneficiary(ies), executor identifier to the non-transitory computer readable medium using the unique identifier.

26. The method of claim 2, wherein the unique identifier printed on the words in waiting car is encoded.

27. The method of claim 2, wherein the recipient identifier, beneficiary(ies) identifier comprises an electronic email address, where the method further comprises the step of:
sending a notification to the electronic email address of the recipient identifier, beneficiary(ies) identifier upon an occurrence of the trigger event.

28. A system for distributing content comprising a non-transitory computer readable medium; a processor executing programming logic for interfacing with a user, the programming logic configured to:
accept a user identifier, a recipient identifier, a beneficiary(ies) identifier, an executor identifier, content, and a trigger event; generate a unique identifier; save the user identifier, recipient identifier, executor identifier content, trigger event, and unique identifier to a non-transitory computer readable medium; accept a recipient, beneficiary(ies), executor update request, where the recipient, beneficiary(ies), executor update request comprises a second recipient, beneficiary(ies), executor identifier and the unique identifier; save the second recipient, beneficiary(ies), executor identifier to the non-transitory computer readable medium using the unique identifier; and provide access to the content after the trigger event and upon receipt of the recipient identifier; a legacy card, where the legacy card comprises the recipient identifier, the beneficiary(ies) identifier, the executor identifier, the trigger event, and the unique identifier; and a words in waiting card, where the words in waiting card comprises the content.
